(19) United States
(12) Patent Application Publication
(10) Pub. No.: US 2002/0041401 A1
(43) Pub. Date: Apr. 11, 2002

(54) Image processing architecture and an image processing method for high scanner

(76) Inventor: Kuo-Kuang Keng, Hsin Chu (TW)

Correspondence Address: J.C. PATENT, INC., SUITE 250, 4 VENTURE, IRVINE, CA, 92618, US

(21) Appl. No.: 09/940,352

(22) Filed: Aug. 27, 2001

(30) Foreign Application Priority Data
Aug. 28, 2000 (TW) 89117337

(51) Int. Cl. H04N 1/40; H04N 1/04

(52) U.S. Cl. 358/443; 358/444; 358/447; 358/471; 358/483

(57) ABSTRACT

An image processing architecture for a scanner, especially used to process the image data output from an analog signal processor by a digital controller, is provided. The image processing architecture of the present invention comprises a ping-pong buffer, an image data storage region and a cache memory. The ping-pong buffer has at least two buffer rows, any of which is used to store the image data. The image data storage region is used to store a correction parameter for image data correction and to store the image data corrected according to the correction parameters. The correction parameters obtained from the image data storage region are stored in the cache memory. The cache memory provides such correction parameters so that the above image data can be corrected in the image processing architecture according the image correction parameter. Additionally, the image processing architecture further includes a cache as a working buffer for line-difference compensation.

### CROSS-REFERENCE TO RELATED APPLICATION

This application claims the priority benefit of Taiwan application serial no. 89117337, filed Aug., 28, 2000.

### BACKGROUND OF THE INVENTION

1. Field of the Invention

The present invention relates to an architecture for a scanner and a process for using the same, more specifically, to an image processing architecture for a scanner and a process for using the same.

2. Description of the Related Art

In a conventional scanner, a charge-coupled device (CCD) generates data at a rate of about 1 to 3 Mega samples per second (MSPS). A device, such as a universal serial bus (USB), has a transmission rate of about 1 MSPS. By using lossless compression, the transmitting rate is extended to about 2 MSPS. Basically, the conventional image processing architecture and the process can utilize almost all of the available input/output bandwidth.

Normally, the data transmission rate would be a bottleneck for the image data throughput of a scanner. However, with enhancements in I/O communication device such as USB 2.0 or IEEE 1394, the data transmission rate has been improved. Additionally, new CCDs can provide a pixel rate of more than 18 MSPS, which is significantly higher than before. Nevertheless, if the image processing architecture and the process for using the same architecture are not improved as the data input/output rate increases, there will not be a significant improvement in the overall data processing speed.

FIG. 1 is a block diagram showing a conventional image processing procedure. The image data generated by a CCD (or a contact image sensor (CIS)) 110 is sent to an analog signal processor (ASP) 115. The image data output from the analog signal processor 115 is transmitted to a digital controller 120. The image data are processed in the digital processor 120 according to parameters stored in a scanner's dynamic random access memory (DRAM) 130. The parameters are for image data correction, such as DC offset, shading gain and gamma for grayscale adjustment. Further, in order to prevent the data from being lost due to the data generation rate being faster than the data transmission rate, the digital controller 120 preliminary stores the processed image data in DRAM 130. Then, the image data are transmitted to the host when the communication device is available.

However, there are some problems in the above-mentioned conventional image processing architecture and the process for using the same. For example, while the image data are corrected in the digital controller 120 according to the image correction parameters such as DC/SH or Gamma, the analog processor 115 cannot transmit data to the digital controller 120. Therefore, the output rate of the CCD/CIS 110 is limited. Moreover, in the prior art, the data that are subject to image data correction in the digital processor 120 are stored in DRAM 130 in a non-pixel rate way. When the data in DRAM 130 are sent to the host, line-difference compensation has to be performed by software in the host and the data has to be re-configured in a pixel rate way, such that the image can be displayed correctly.

In view of the foregoing, the disadvantages in the prior art are summarized as follows:

1. The output rate of the CCD/CIS is limited because of the image data correcting speed of the digital controller; and

2. After the data in DRAM are transmitted to the host, line-difference compensation has to be performed by software in the host and the data has to be configured in a pixel rate way. Such an operation takes time to perform and causes the delay of image display.

### SUMMARY OF THE INVENTION

Therefore, it is an object of the present invention to provide an image processing architecture for a scanner, especially used to process image data output from an analog signal processor by a digital controller. The image processing architecture of the present invention comprises a pingpong buffer, an image data storage media and a cache memory. The ping-pong buffer has multiple rows, any of which are used to store the image data. The image data storage region is used to store image data correction parameters and the image data are corrected according to the image data correction parameters. The correction parameter obtained from the image data storage region is stored in the cache memory. The cache memory provides such correction parameters so that the above image data can be corrected in the image processing architecture according to these parameters. The image processing architecture can further include an additional cache as a work space for line-difference compensation.

The present invention further provides a method of processing scanner image data, especially used by a digital controller to process the image data output from an analog signal processor. The method of the present invention comprises storing the input image to one of the multiple rows. Two buffers are usually used. A correction parameter required for image data processing is taken from cache memory. Then, image data correction is carried out according to the correction parameter. While the image data is being corrected, the sequential image data received from the analog signal processor is stored in another row. After correction for the former is completed, the ping-pong buffer is switched to continue processing by the same procedure.

The image processing method of the present invention further comprises the steps of storing corrected image data; reading the RGB data of the corrected image data; and performing line-difference compensation to configure the image data in pixel rate order in another cache memory.

In view of the foregoing, a cache and a ping-pong buffer are used such that the sequential image data generating rate will not slow down when the image data correction is performed. Moreover, sequential image data processing such as line-difference and pixel-packing can be carried out in scanner to reduce operations required to be performed in the host and speed up the output of the image data from a scanner.

### BRIEF DESCRIPTION OF THE DRAWINGS

For understanding the foregoing general description, the following example is intended to provide further explanation of the invention as claimed.

The accompanying drawings are included to provide a further understanding of the invention, and are incorporated in and constitute a part of this specification. The drawings illustrate embodiments of the invention and, together with the description, serve to explain the principle of the invention. In the drawings,

FIG. 1 is a block diagram showing a conventional image processing procedure; and

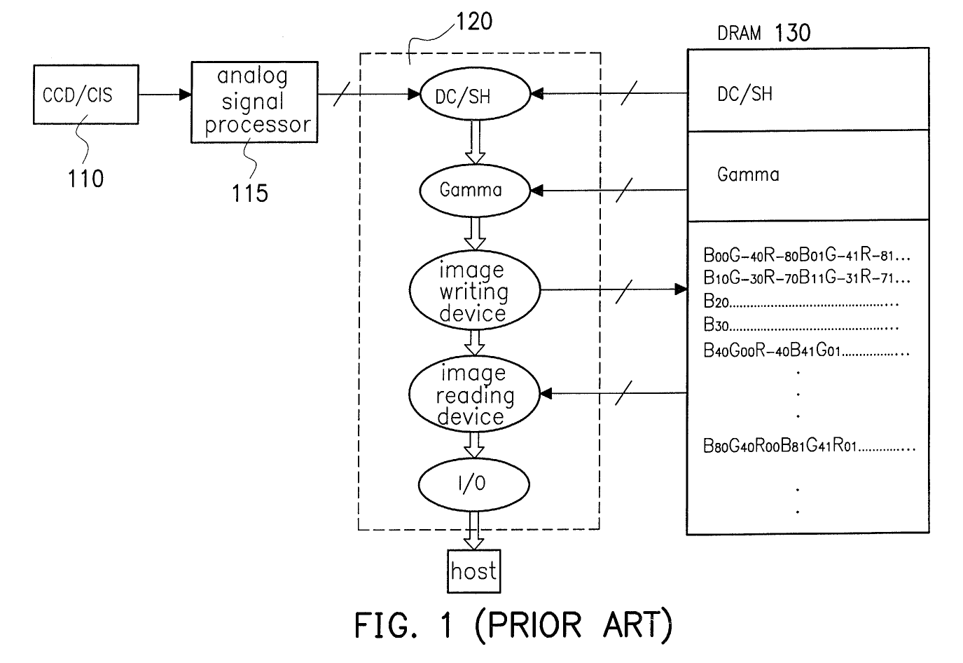

FIG. 2 is a block diagram showing an image processing procedure according to a preferred architecture of the present invention.

### DETAILED DESCIPTION OF PREFERRED ARCHITECTURES

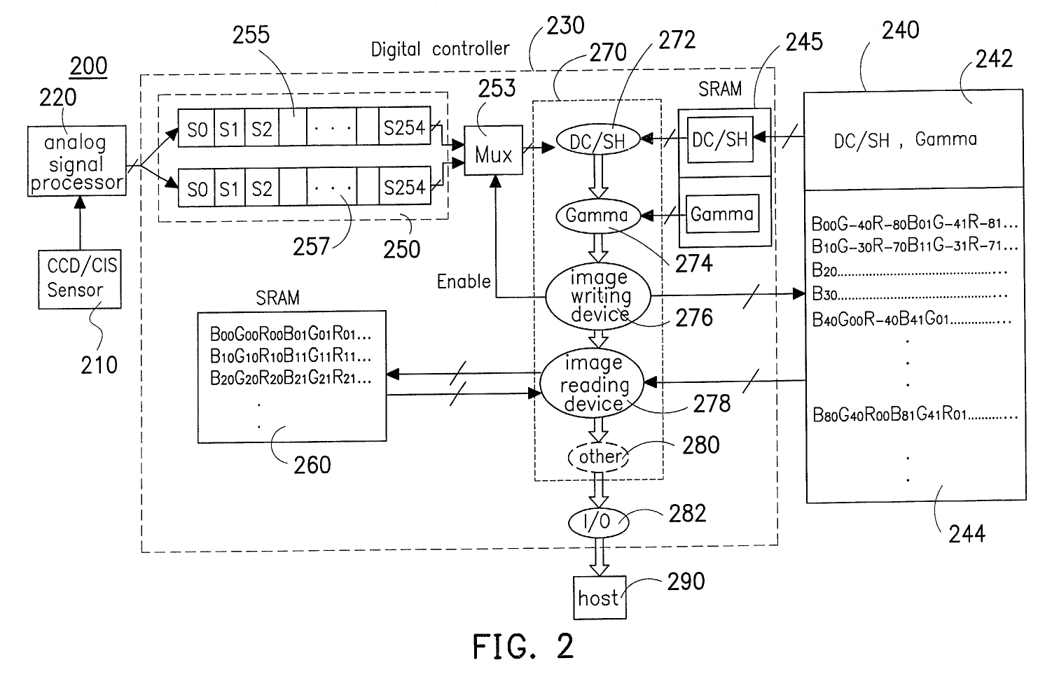

Referring to FIG. 2, a block diagram showing an image processing procedure according to one preferred architecture of the present invention. The image processing device 200 comprises a charge coupled device (CCD) or a contact image sensor (CIS) 210, an analog signal processor (ASP) 220, a ping pong buffer 250, an image data storage region 240 and cache memories 245 and 260. It is noted that although DRAM is used as an image storage media in this example, it does not mean that DRAM is the only choice for storage media in this invention.

The image data generated by the CCD/CIS 210 are sent to the ping-pong buffer 250 in the digital controller 230 after being processed in the analog signal processor 220. In this architecture, the ping-pong buffer 250 has two buffer rows 255 and 257 both of which have 255 words. Of course, it is not intended to limit use of a ping-pong buffer consisting of two buffer rows or limit each buffer row to have only 255 words. In this architecture, the image data transmitted from the analog signal processor 220 are stored in the buffer row 255. When the image data in the buffer row 255 had achieved a certain level, the image data stored in the buffer row 255 are transmitted to the digital controller 230 by a multiplexer (MUX) 253 to perform image processing in the image processing device 270. Meanwhile, the image data sequentially transmitted to the digital controller 230 from the analog signal processor 220 are stored in the buffer row 257. Also, when the image data stored in the buffer row 257 is being processed in the image processing device 270, the image data sequentially sent to the digital controller 230 from the analog signal processor 220 are stored in the buffer row 255.

When the image data in the ping-pong buffer 250 are transmitted to the image processing device 270 by the multiplexer 253, an image correction parameter stored in an image correction parameter storage region 242, such as DC offset, shading gain (SH), and Gamma for grayscale adjustment are written into the cache memory 245 from the image correction parameter storage region 242. After the image processing begins, these values are sent individually to the image processing device 270 in order to correct the image data transmitted from the multiplexer 253. Image corrections are performed by a DC/SH image processing device 272 and a Gamma processing device 274. The image data corrected by the DC/SH image processing device 272 and the Gamma processing device 274 are written into the processed image storage region 244 of the image data storage 240 by the image writing device 276. Due to the configuration of the CCD optical electronic components, a line-difference exists with respect to the image data obtained from the CCD (no line-difference in the case of CIS). A 4 line-difference in BGR data stored in the processed image storage region 244 is assumed for example.

When the first BLUE pixel is at line 0 (B₀₀), the first GREEN pixel is at line 4 (G₋₄₀) where it needs to continue passing 4 lines until reaching the starting point for scanning documents, and the first RED dot is at line 8 (R₋₈₀) where it needs to continue passing 8 lines until reaching the starting point for scanning documents. The first numeral after the letter such as B₀₀, G₋₄₀ or R₋₈₀ represents the line number and the second numeral shows the pixel number. Therefore, when the CCD passes through a line, the first BLUE dot is at the first line (B₁₀), the first GREEN dot is at line 3 (G₋₃₀), and the first RED dot is at line 7 (R₋₇₀). Of course, it should be understood that line-difference and the order of color can be various depending on the CCD design. The situation in this example for illustration and therefore it is not intended to limit the application of the present invention.

When the processed image data are transmitted to a host 290, the image reading device 278 reads the corrected image data stored in the processed image storage region 244. The corrected image data are re-arranged according to line-difference, configured in pixel rate order and stored in the cache memory 260. That is, before the corrected image data are transmitted to the host 290, the line-difference compensation and pixel-packing are performed in the scanner. After the corrected image data are configured in a pixel rate way, the image reading device 278 reads the processed image data that are stored in the cache memory 260. The processed image data are then transmitted to the host 290 from the image output device 282.

More concretely, the analog signal processor in this example is 16-bit. The DRAM used is synchronous DRAM (SDRAM). When the image generating speed of the analog signal processor is 18 Mega samples per second (MSPS) and the system operation frequency is 108 MHz, three 16-bits data are generated every 18 system clock cycles (six clock cycles for each RED, GREEN and BLUE data). If the size of a buffer row in the ping-pong buffer is 255×16-bit, it takes 255*6 (1530) system clock cycles to fill a buffer row.

Table 1

| | Data size | Overhead depending | |
|---|---|---|---|
| | Unit: word | on memory | Amount of time |
| DC/SH | 256 + 256 | 21 | 533 |
| Image data writing | 255 | 14 | 269 |
| Image data reading | 255 | 42 | 297 |

From FIG. 2 and Table 1, it is clear that when the image data of each buffer row are processed, DRAM has to be accessed three times. In the first access, the DC/SH correction parameter is read. In the second access, the image writing device 276 writes the corrected image data to DRAM 240. In the third access, the image reading device 278 reads the corrected image data from DRAM 240. The time required for the first access is 256+256 system clock cycles. The time required for the second access and the third access is 256 system clock cycles for each access. The overhead for the first, second and third access of DRAM is about 21, 14, and 42 system clock cycles, respectively. The total time required is about 1099 system clock cycles. Of course, the overhead required for access can be varied according to the DRAM specifications. In this example, the total time to access DRAM is 1199 system clock cycles which includes 100 system clock cycles required for refreshing SDRAM. Therefore, the residual period of time can be used for other additional image processing procedures, such as color conversion or filtering.

Further, the writing of corrected image data is synchronized with the calculation of DC/SH and Gamma mapping in the pipeline. In the case that 255 16-bit data are processed in the pipeline, only about 260 system clock cycles are needed. The time required for DC/SH, Gamma mapping, writing corrected image data and overhead would be no more than 300 system clock cycles. Among the 1530 system clock cycles required for filling a buffer row with image data, 533 system clock cycles are used for reading DC/SH corrected image data, 297 system clock cycles are used for reading the corrected image and 300 system clock cycles are used for DC/SH, Gamma process and writing corrected image data. Therefore, about 400 system clock cycles are left and can be used to perform other image processing.

In the foregoing, the present invention has the following advantages. Ping-pong buffers and cache memory are used in the present invention to increase the processing speed for image data correction. Further, the architecture of the present invention can optionally perform line-difference compensation and pixel packing in the scanner hardware, to decrease the operations needed to be performed in the host. Image delay can thus be prevented.

It will be clear to those skilled in the art that several changes and modifications of an obvious nature may be made without departing from the spirit of the invention, and such changes and modifications are considered to fall within the scope of the invention as defined by the following claims.

What is claimed is:

1. An image processing architecture for an image input apparatus, comprising:
a ping-pong buffer having multiple rows for storing image data;
an image data storage media for storing correction data used to correct the input image, and the said storage media is used to store the corrected image according to the said correction data; and
a first cache memory for storing the correction data read from the image storage media and for providing the correction data to a digital controller to correct the said input image according to the correction data.

2. The image processing architecture as defined in claim 1, further including a second cache memory which is used as a work space for line-difference compensation data arrangement of the said input image.

3. A method of processing an scanned image, comprising:
a. storing image to one of the rows of the said ping-pong buffer;
b. reading correction data required for image correction from the cache memory;
c. correcting the said input image according to the correction data, and storing the succeeding input image to another rows, the said succeeding input image is received from the input signal processor; and
d. correcting the said input image sequentially while the previous image data is corrected.

4. The method of processing a scanned image as defined in claim 3, further comprising:
storing corrected image;
reading RGB data of the corrected image;
performing line-difference compensation; and
arranging image data in pixel rate order.
